(19) United States
(12) Patent Application Publication
(10) Pub. No.: US 2016/0326406 A1
(43) Pub. Date: Nov. 10, 2016

(54) ADHESIVE OPTICAL MEMBER

(71) Applicant: NITTO DENKO CORPORATION, Osaka (JP)

(72) Inventors: Yutaka MOROISHI, Osaka (JP); Fumiko NAKANO, Osaka (JP); Tetsuo INOUE, Osaka (JP); Masayuki SATAKE, Osaka (JP)

(73) Assignee: NITTO DENKO CORPORATION, Osaka (JP)

(21) Appl. No.: 15/211,040

(22) Filed: Jul. 15, 2016

Related U.S. Application Data
(62) Division of application No. 14/004,733, filed on Sep. 12, 2013.

(30) Foreign Application Priority Data
Mar. 14, 2011 (JP) 2011-055449

(51) Int. Cl. C09J 7/02; G02B 5/30; C09J 175/04

(52) U.S. Cl. CPC C09J 7/0246; C09J 175/04; G02B 5/30; C09J 2475/00

(57) ABSTRACT

Provided are: a pressure-sensitive adhesive composition for optical members having excellent durability, adhesiveness (adhesion), and removability; a pressure-sensitive adhesive layer for optical members that uses the pressure-sensitive adhesive composition; an adhesive optical member; and an image display device. The pressure-sensitive adhesive composition for optical members is characterized by containing 0.02 to 5 parts by weight of a curing catalyst, and 0.2 to 5 parts by weight of an isocyanate compound, with respect to 100 parts by weight of a polymer having a reactive silicon group with a weight average molecular weight of 2000 to 50000 on or near a molecular terminal.

### TECHNICAL FIELD

The invention relates to a pressure-sensitive adhesive composition for an optical member, a pressure-sensitive adhesive layer for an optical member made from the pressure-sensitive adhesive composition, an adhesive optical member having the pressure-sensitive adhesive layer, and an image display device produced with the adhesive optical member.

### BACKGROUND ART

An optical member, such as a polarizing plate or a retardation plate, used to form a liquid crystal display device or the like is bonded to a liquid crystal cell with a pressure-sensitive adhesive. The material used in such an optical member can significantly expand or contract under heating or humidified conditions and thus can easily cause lifting or peeling after it is bonded. Thus, pressure-sensitive adhesives for use on optical members are required to be durable even under heating or humidified conditions.

When an optical member being bonded to a liquid crystal cell catches a contaminant on its surface being bonded or is misaligned from the position to be bonded, the optical member should be peeled off from the liquid crystal cell so that it can be reused. When peeled off from the liquid crystal cell, the optical member is required not to be in an adhesion state that can change the gap of the liquid crystal cell or break the optical member. In other words, removability is required so that the optical member can be easily peeled off. However, if techniques for simply improving adhesion (pressure-sensitive adhesion) are used with the emphasis on the durability of pressure-sensitive adhesives for use on optical members, the resulting pressure-sensitive adhesives will have lower removability, so that it will be difficult to achieve durability and removability (reusability) at the same time.

Under these circumstances, various pressure-sensitive adhesive materials for use on the optical members are proposed. For example, an acryl-based polymer with a high molecular weight is used and mixed with a crosslinking agent and a silane coupling agent, and the mixture is applied to various supports and dried to be used (Patent Document 1).

Now, in view of environmental health or safety, there is a trend not to use organic solvents in the production of pressure-sensitive adhesives, and emulsion-type pressure-sensitive adhesives produced using water as a solvent are coming to be used. Unfortunately, pressure-sensitive adhesives produced with water have a problem such as a relatively long time required for the drying process.

Thus, solvent-free pressure-sensitive adhesives, which require no drying process, have also been developed. For example, there are proposed urethane-based pressure-sensitive adhesives obtained by introducing a hydroxyl group to the molecular end of a low-molecular-weight polymer and allowing the polymer to react with an isocyanate crosslinking agent; and silicone-based pressure-sensitive adhesives produced using a polymer having a silyl group introduced to the molecular end.

### PRIOR ART DOCUMENT

### Patent Document

Patent Document 1: JP-A-64-66283

### SUMMARY OF THE INVENTION

### Problems to be Solved by the Invention

However, the use of an emulsion-type pressure-sensitive adhesive has the problem of low water resistance. When such an emulsion-type pressure-sensitive adhesive is bonded to an optical member and allowed to stand under high-temperature, high-humidity conditions, lifting or peeling can occur, or water can infiltrate from the bonded interface to cause a problem with durability, such as cloudiness.

At present, when solvent-free pressure-sensitive adhesives produced with a low-molecular-weight polymer are used, problems can occur, such as insufficient durability, the decrease in removability with increasing adhering strength (adhesive strength), incapability to relax stress uniformly, and color irregularities or white spots caused by residual stress on an optical member (such as a polarizing plate), and a satisfactory level of durability or tackiness (adherability) and removability cannot be obtained.

In light of these circumstances, an object of the invention is to provide a pressure-sensitive adhesive composition having a high level of durability, tackiness (adherability), and removability for use on an optical member and to provide a pressure-sensitive adhesive layer for an optical member, an adhesive optical member, and an image display device each produced with such a pressure-sensitive adhesive composition.

### Means for Solving the Problems

Therefore, to achieve the object, the inventors have made earnest study of components for pressure-sensitive adhesive compositions, and as a result, have accomplished the invention based on the finding that the object can be achieved using the pressure-sensitive adhesive composition for an optical member according to the invention.

Specifically, the invention is directed to a pressure-sensitive adhesive composition for an optical member, which includes 100 parts by weight of a polymer having a reactive silicon group at a molecular end or in the vicinity of the end and having a weight average molecular weight of 2,000 to 50,000, 0.02 to 5 parts by weight of a curing catalyst, and 0.2 to 5 parts by weight of an isocyanate compound.

In the pressure-sensitive adhesive composition for an optical member of the invention, the polymer having a reactive silicon group at a molecular end or in the vicinity of the end is preferably a product synthesized by introducing a reactive silicon group to a hydroxyl group of a polymer that has the hydroxyl group at a molecular end or in the vicinity of the end and has a weight average molecular weight of 2,000 to 50,000.

In the pressure-sensitive adhesive composition for an optical member of the invention, the polymer having a hydroxyl group at a molecular end or in the vicinity of the end is preferably a polyacrylic ester-based polymer or a polyoxyalkylene-based polymer.

The pressure-sensitive adhesive composition for an optical member of the invention preferably further contains 0.02 to 2 parts by weight of a silane coupling agent.

The pressure-sensitive adhesive layer for an optical member of the invention preferably includes a crosslinking product of the pressure-sensitive adhesive composition for an optical member, wherein the crosslinking product preferably has a gel fraction of 40 to 85% by weight.

The adhesive optical member of the invention preferably includes an optical member and the pressure-sensitive adhesive layer provided on one or both sides of the optical member.

In the adhesive optical member of the invention, the optical member is preferably at least one selected from a polarizing plate, a retardation plate, and an elliptically polarizing plate.

The image display device of the invention preferably includes at least one piece of the adhesive optical member.

### Effect of the Invention

The pressure-sensitive adhesive composition for an optical member of the invention, which contains specific amounts of a curing catalyst and an isocyanate compound (crosslinking agent) together with a polymer having a reactive silicon group at a molecular end or in the vicinity of the end and having a weight average molecular weight of 2,000 to 50,000, is useful in that a pressure-sensitive adhesive (layer) obtained by crosslinking the composition can be prevented from causing lifting, peeling, or foaming even after it is used to bond a liquid crystal cell to an optical member and then stored under high-temperature, high-humidity conditions, so that high durability can be achieved. In addition, even when the optical member is peeled off so that the liquid crystal cell can be reused, the adhering strength (adhesive strength) can be kept from increasing, and the optical member can be easily peeled off with no adverse effect on the liquid crystal cell, which is useful in that good removability (reusability) can be achieved and color irregularities or white spots caused by residual stress on the optical member can be prevented.

### MODE FOR CARRYING OUT THE INVENTION

The pressure-sensitive adhesive composition for an optical member of the invention contains, as a base polymer, a polymer having a reactive silicon group at a molecular end (terminal) or in the vicinity of the end and having a weight average molecular weight of 2,000 to 50,000, preferably 3,000 to 45,000, more preferably 4,000 to 45,000. The polymer having too low a weight average molecular weight is not preferred because it can have too low adhering strength and thus an adverse effect on durability. The polymer having too high a weight average molecular weight is also not preferred because it can have too high adhering strength and thus reduced removability. The reactive silicon group may be a reactive group capable of causing a siloxane bond-forming reaction through hydrolysis, such as a methoxysilyl group or an ethoxysilyl group.

The polymer having the reactive silicon group at a molecular end or in the vicinity of the end is preferably a product synthesized by introducing a reactive silicon group to a hydroxyl group of a polymer that has the hydroxyl group at a molecular end or in the vicinity of the end and has a weight average molecular weight of 2,000 to 50,000, more preferably 3,000 to 45,000, particularly preferably 4,000 to 45,000. The polymer having a hydroxyl group at a molecular end or in the vicinity of the end is useful because the reactive silicon group can be easily introduced using it.

The polymer having a hydroxyl group at a molecular end or in the vicinity of the end may have at least two or more hydroxyl groups per molecule. Its skeleton may be of any type such as polybutadiene polymer, polyisoprene polymer, polyoxyalkylene polymer, polyacrylic ester-based polymer, or any blend thereof. In view of transparency or durability, the use of polyoxyalkylene polymer or polyacrylic ester-based polymer is particularly preferred.

Examples of the polyoxyalkylene polymer include products obtained by addition polymerization of ethylene oxide, propylene oxide, tetrahydrofuran, or the like with a low molecular weight polyol such as a dihydric alcohol such as ethylene glycol, diethylene glycol, propylene glycol, butylene glycol, or hexamethylene glycol or a trihydric alcohol such as trimethylolpropane, glycerin, or pentaerythritol.

Also may be used a polyoxyalkylene polymer having urethane moieties as part of its molecular chain extended through urethane bonds formed using the polyol (alcohol) and a diisocyanate.

The polyacrylic ester-based polymer may be a copolymer of an alkyl (meth)acrylate monomer as a main component and any other copolymerizable monomer(s), the copolymer having a hydroxyl group at a molecular end or in the vicinity of the end. Specific examples of such an acrylic ester monomer include methyl (meth)acrylate, ethyl (meth)acrylate, propyl (meth)acrylate, butyl (meth)acrylate, pentyl (meth)acrylate, hexyl (meth)acrylate, heptyl (meth)acrylate, isoamyl acrylate, 2-ethylhexyl (meth)acrylate, isooctyl (meth)acrylate, isononyl (meth)acrylate, isomyristyl (meth)acrylate, phenoxyethyl (meth)acrylate, isobornyl (meth)acrylate, etc. These alkyl (meth)acrylates may be used alone or in combination of two or more. As used herein, the term “(meth)acrylate” means acrylate and/or methacrylate.

Hydroxyl groups can be introduced to molecular ends of a polymer or to the vicinity of molecular ends of a polymer by a method using a hydroxyl group-containing polymerization initiator or chain transfer agent. If such a method is used, however, a polymer having no hydroxyl group can also be produced, and a pressure-sensitive adhesive finally produced with such a polymer can cause a problem such as adhesive residue staining during removal or degradation in durability. Therefore, living radical polymerization is preferably used to introduce a hydroxyl group to at least one molecular end or the like of a polymer.

In a preferred mode, the living radical polymerization is performed using a method of polymerizing a polymerizable monomer in the presence of a transition metal, a ligand, and a polymerization initiator.

A metal species such as Cu, Ru, Fe, Rh, V, or Ni, a halide of the metal species (a salt such as a chloride or a bromide), or a complex of the metal species may be used for the transition metal.

Examples of the ligand that may be used include, but are not particularly limited to, bipyridyl derivatives, mercaptan derivatives, and trifluorate derivatives. Among them, the use of a Cu(1)-2,2′-bipyridyl complex is particularly preferred for stability of polymerization and rate of polymerization.

The polymerization initiator preferably has a hydroxyl group. Specifically, an ester or styrene derivative compound containing bromine or chlorine in the α-position and a hydroxyl group in the molecule may be used as long as it does not inhibit the progress of the living radical polymerization. More specifically, a halide compound selected from 2-hydroxyethyl 2-bromo(or chloro)propionate, 4-hydroxybutyl 2-bromo(or chloro)propionate, 2-hydroxyethyl 2-bromo(or chloro)-2-methylpropionate, and 4-hydroxybutyl 2-bromo(or chloro)-2-methylpropionate may be used. When such a hydroxyl group-containing polymerization initiator is used, the resulting block polymer also has a hydroxyl group at its end, in which the hydroxyl group is derived from the polymerization initiator.

A hydroxyl group may be further introduced to another molecular end of the polymer or the vicinity of the end of the polymer. To introduce such a hydroxyl group, a hydroxyl group-containing polymerizable monomer may be added, such as 2-hydroxyethyl (meth)acrylate, 3-hydroxypropyl (meth)acrylate, 4-hydroxybutyl (meth)acrylate, or 6-hydroxyhexyl (meth)acrylate. In this case, the timing of the addition of the hydroxyl group-containing polymerizable monomer is not particularly restricted. To obtain good tackiness (adherability), however, the hydroxyl group-containing polymerizable monomer is preferably introduced at a polymerization stage as later as possible. Specifically, the hydroxyl group-containing polymerizable monomer is preferably introduced at a time when the rate of polymerization for the polymer reaches 80% or more. When the hydroxyl group-containing polymerizable monomer is added at a later stage of polymerization, the hydroxyl group can be introduced to a site closer to a molecular end. In this case, the hydroxyl group derived from the polymerization initiator is also located at another molecular end or the like, so that two or more hydroxyl groups can be introduced in a specific manner called “telechelic,” which is a preferred mode. When two or more hydroxyl groups are introduced in a telechelic manner to the polymer as described above, the polymer can be linearly extended by the crosslinking reaction described below. This makes it possible to form a uniform crosslinked product with small variations in the distance between crosslinks and also makes it possible to obtain better tackiness (adherability), and thus is a preferred mode. In the living radical polymerization, a block polymer can also be synthesized, and thus physical properties can be controlled by the synthesis of the block polymer using a combination of two or more monomers.

The reactive silicon group is preferably introduced using the hydroxyl group of the polymer obtained as described above, which has a weight average molecular weight of 2,000 to 50,000 and has the hydroxyl group at a molecular end or in the vicinity of the end. Examples of the method of introducing the reactive silicon group include, but are not particularly limited to, a method of performing a reaction between the hydroxyl group of the polymer and a compound having an isocyanate group and a reactive silicon group containing an alkoxy group such as a methoxy, ethoxy, or propoxy group; and a method including allowing a diisocyanate to react with the hydroxyl group of the polymer to introduce the isocyanate group to the polymer and then allowing the product to react with a compound having a reactive silicon group and an amino group, which can be conveniently used. Examples of the compound having a reactive silicon group and an isocyanate group include 3-isocyanatopropyltriethoxysilane, 3-isocyanatopropyltrimethoxysilane, 3-isocyanatopropylmethyldimethoxysilane, etc. These may be used alone or in combination of two or more.

Examples of the compound having a reactive silicon group and an amino group include N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropylmethyldimethoxysilane, etc. These may be used alone or in combination of two or more.

The pressure-sensitive adhesive composition for an optical member of the invention is also characterized by containing 100 parts by weight of the polymer having a reactive silicon group at a molecular end or in the vicinity of the end, 0.02 to 5 parts by weight of a curing catalyst, and 0.2 to 5 parts by weight of an isocyanate compound.

Examples of the curing catalyst include titanium-based catalysts such as tetrabutyl titanate and bisacetylacetodiisopropoxytitanium; tin-based catalysts such as dibutyltin dilaurate and dibutyltin diacetylacetate; and aluminum-based catalysts such as aluminum trisacetylacetate and aluminum trisethylacetoacetate. These may be used alone or in combination of two or more.

The content of the curing catalyst is from 0.02 to 5 parts by weight, preferably from 0.03 to 4 parts by weight, more preferably from 0.05 to 3 parts by weight, based on 100 parts by weight of the polymer having a reactive silicon group at a molecular end or in the vicinity of the end. If the content of the curing catalyst is too low, the curing reaction will be slow, and if it is too high, the curing will be so fast as to cause a problem with workability, which is not preferred.

Examples of the isocyanate compound include diisocyanates such as tolylene diisocyanate, diphenylmethane diisocyanate, xylylene diisocyanate, isophorone diisocyanate, and hexamethylene diisocyanate, diisocyanate adducts modified with various polyols, and polyisocyanate compounds having an isocyanurate ring, a biuret moiety, or an allophanate moiety. These may be used alone or in combination of two or more.

The content of the isocyanate compound is from 0.2 to 5 parts by weight, preferably from 0.3 to 4 parts by weight, more preferably from 0.3 to 3 parts by weight, based on 100 parts by weight of the polymer having the introduced reactive silicon group. If the content of the isocyanate compound is too low, there will be a problem with durability at high-temperature and high-humidity, and if it is too high, durability will be low at high temperature, which is not preferred.

The pressure-sensitive adhesive composition for an optical member of the invention preferably further contains 0.02 to 2 parts by weight, more preferably 0.02 to 1 part by weight of a silane coupling agent, based on 100 parts by weight of the polymer having the introduced reactive silicon group. If the content of the silane coupling agent is too high, the pressure-sensitive adhesive layer can have higher adhering strength to a liquid crystal cell or the like and have lower removability, and if it is too low, durability can undesirably decrease. The silane coupling agent is also preferable because when the silane coupling agent is added to the composition, the polymer having the reactive silicon group (such as a silyl group) can have more improved adhesive properties to glass and other objects, although the polymer already has sufficient adhesive properties to glass and other objects.

Examples of the silane coupling agent include epoxy group-containing silane coupling agents such as 3-glycidoxypropyltrimethoxysilane, 3-glycidoxypropylmethyldiethoxysilane, and 2-(3,4-epoxycyclohexyl)ethyltrimethoxysilane; amino group-containing silane coupling agents such as 3-aminopropyltrimethoxysilane, N-2-(aminoethyl)-3-aminopropylmethyldimethoxysilane, 3-triethoxysilyl-N-(1,3-dimethyl-butylidene)propylamine, and N-phenylaminopropyltriethoxysilane; (meth)acrylic group-containing silane coupling agents such as 3-acryloxypropyltrimethoxysilane and 3-methacryloxypropyltriethoxysilane; and isocyanate group-containing silane coupling agents such as 3-isocyanatopropyltriethoxysilane.

The pressure-sensitive adhesive composition for an optical member of the invention may further contain any other known additive. Examples include a power of a colorant, a pigment or the like, a dye, a surfactant, a plasticizer, a surface lubricant, a leveling agent, a softening agent, an antioxidant, an age resistor, a light stabilizer, an ultraviolet absorbing agent, a polymerization inhibitor, an inorganic or organic filler, a metal powder, and a particulate or flaky material, which may be added as appropriate depending on the intended use. In this case, the amount of the addition should be adjusted so as not to significantly change the elastic modulus of the pressure-sensitive adhesive layer.

In some cases, the pressure-sensitive adhesive composition for an optical member of the invention may be solvent-free when used. Taking workability into account, the pressure-sensitive adhesive composition of the invention may also be dissolved in a small amount of a solvent and used in the form of a solution. Alternatively, the pressure-sensitive adhesive composition of the invention can be molten by heating and thus may be used in a molten state under heating with no solvent. Examples of the solvent include methyl ethyl ketone, acetone, ethyl acetate, tetrahydrofuran, dioxane, cyclohexanone, n-hexane, toluene, xylene, methanol, ethanol, n-propanol, isopropanol, etc. These solvents may be used alone or in combination of two or more.

An adhesive optical member can be produced by directly applying the pressure-sensitive adhesive composition to an optical member so that a pressure-sensitive adhesive layer for the optical member is formed. Alternatively, an adhesive optical member can be produced by a process including applying the pressure-sensitive adhesive composition to a release-treated support to forma pressure-sensitive adhesive layer for an optical member and then transferring the pressure-sensitive adhesive layer onto an optical member.

Any of a plastic film, a paper sheet, a laminated paper sheet, a nonwoven fabric, a metal foil, and a foamed sheet may be used as needed as the release-treated support. In particular, a plastic film is preferably used because of its good surface smoothness.

Examples of the plastic film include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, etc.

The thickness of the release-treated support is generally, but not limited to, about 5 to 200 μm, preferably about 5 to 100 μm. If necessary, the release-treated support may be subjected to a release treatment and an anti-pollution treatment with a silicone, fluoride, long-chain alkyl, or fatty acid amide release agent, silica powder or the like, or subjected to an antistatic treatment of coating type, kneading and mixing type, vapor-deposition type, or the like. In particular, when the surface of the separator is appropriately subjected to a release treatment such as a silicone treatment, a long-chain alkyl treatment, or a fluorine treatment, the removability from the pressure-sensitive adhesive layer can be further improved.

When the pressure-sensitive adhesive composition is used in the form of a solution, a pressure-sensitive adhesive layer can be formed by applying the composition and then drying the composition. In this case, the method of application may be any coating method such as a method using a roll coater such as a reverse coater or a gravure coater, a curtain coater, a lip coater, or a die coater. For example, the method of applying the pressure-sensitive adhesive composition in a molten state with no solvent may be a method including kneading the composition with a heating kneader or a uniaxial or biaxial kneader to make it uniform and applying the composition with a heating die coater.

The pressure-sensitive adhesive composition for an optical member contains an isocyanate compound (crosslinking agent) and thus can be crosslinked as needed by a heat treatment or the like. When the pressure-sensitive adhesive composition is used in the form of a solution, the crosslinking process may be performed at the temperature of the process of removing the solvent by drying, or an independent crosslinking process may be performed after the drying process.

When the pressure-sensitive adhesive layer is formed, the content of the isocyanate compound (crosslinking agent) is preferably controlled so that the crosslinked pressure-sensitive adhesive layer can have a gel fraction of 40 to 85% by weight, more preferably 45 to 80% by weight. As the gel fraction decreases, the cohesive strength may decrease, and the holding power may become insufficient. On the other hand, as the gel fraction increases, the adhering strength (adhesive strength) may become insufficient, which is not preferred in view of tackiness (adherability).

The pressure-sensitive adhesive layer preferably has a thickness of 2 to 500 μm, more preferably 5 to 100 μm, after dried. The surface of the pressure-sensitive adhesive layer to be bonded to an optical member may be subjected to an adhesion-facilitating treatment such as a corona treatment, a plasma treatment, or formation of an adhesion facilitating layer, or subjected to formation of an antistatic layer. When the surface of the pressure-sensitive adhesive layer is exposed in this manner, the pressure-sensitive adhesive layer may be protected by a release-treated sheet (a release sheet, a separator, or a release liner) until it is actually used.

The optical member for use in the invention may be any type capable of being used to form an image display device such as a liquid crystal display device. Examples of the optical member include a polarizing plate, a retardation plate, and any other material that can be used as an optical layer to form an image display device (such as a liquid crystal display device). The polarizing plate generally used includes a polarizer and a transparent protective film or films provided on one or both sides of the polarizer. These optical members may be used alone, or one or more layers of any of the optical members may be used with the polarizing plate to form a laminate for practical use. An elliptically or circularly polarizing plate including the polarizing plate and a retardation plate further placed thereon may also be used as the optical member.

The optical member can expand or contract depending on the heat or humidity during the evaluation of durability. Thus, the starting material to be used for the pressure-sensitive adhesive may be selected taking into account birefringence which will be caused by such expansion or contraction of the optical member. For example, in a case where the optical member shows negative birefringence as it expands or contracts, a material capable of producing positive birefringence may be used to form the pressure-sensitive adhesive, so that an advantageous effect such as suppression of birefringence-induced light leakage or color irregularities can be produced. For example, the pressure-sensitive adhesive composition for an optical member can show negative birefringence when containing a polyacrylic ester-based polymer, while it can show positive birefringence when containing a polyoxyalkylene polymer. Thus, the polymer may be selected depending on the situation. The addition of the polymer also makes it possible to control the deformation-induced birefringence of the pressure-sensitive adhesive itself.

In a preferred embodiment of the invention, at least one piece of the adhesive optical member is used in an image display device (such as a liquid crystal display device). The adhesive optical member is useful to achieve a high level of durability and removability and to prevent color irregularities or white spots, which would otherwise be caused by residual stress on the optical member.

The liquid crystal display device can be formed according to conventional techniques. For example, a liquid crystal display device can be formed by properly assembling a liquid crystal cell, the adhesive optical member, and optional components such as lighting system components, incorporating a driving circuit, and performing other processes.

### EXAMPLES

Hereinafter, the invention will be more specifically described with reference to examples, which however are not intended to limit the invention. The weight average molecular weight and the gel fraction were determined using the methods described below.

(Method for Measuring Molecular Weight)

The weight average molecular weight was measured by gel permeation chromatography (GPC) under the following conditions.

Analyzer: HLC-8120GPC manufactured by TOSOH CORPORATION

Columns (for styrene-based block elastomer): G7000H_{XL}-H+GMH_{XL}-H+GMH_{XL} manufactured by TOSOH CORPORATION

Columns (for tackifier): GM_{HR}-H+GMH_{HR}+G2000MH_{HR} manufactured by TOSOH CORPORATION

Column size: each 7.8 mmφ×30 cm, 90 cm in total

Column temperature: 40° C.

Flow rate: 0.8 mL/minute

Eluent: tetrahydrofuran

Solution concentration: about 0.1% by weight

Injection volume: 100 μL

Detector: differential refractometer (RI)

Standard sample: polystyrene

Data processer: GPC-8020 manufactured by TOSOH CORPORATION

(Gel Fraction)

About 0.1 g of the pressure-sensitive adhesive layer was sampled, and its weight (W₁) was measured. The weighed pressure-sensitive adhesive layer was immersed in about 50 ml of ethyl acetate at 23° C. for 1 week, and then the soluble part was extracted. The pressure-sensitive adhesive layer, from which the soluble part was extracted, was then taken out and dried at 120° C. for 2 hours, and measured for weight (W₂). The gel fraction (% by weight) of the pressure-sensitive adhesive layer was determined from the measured values according to the following formula.

Gel fraction (% by weight)=(W₂/W₁)×100

### Example 1

### Preparation of Pressure-Sensitive Adhesive Composition

<Synthesis of Polymer Having Hydroxyl Groups at Molecular Ends and so on>

To a four-necked flask, equipped with a mechanical stirrer, a nitrogen-introducing inlet, a condenser tube, and a rubber septum, were added 300 parts by weight of butyl acrylate and 1.0 part by weight of 2,2′-bipyridine, and the air in the system was replaced by nitrogen. Under a nitrogen stream, 0.3 parts by weight of copper bromide was added to the mixture. Subsequently, the reaction system was heated at 100° C., and 0.8 parts by weight of 2-hydroxyethyl 2-bromo-2-methylpropionate as an initiator was added to initiate polymerization. Without addition of any solvent, the mixture was subjected to polymerization at 100° C. for 12 hours under a nitrogen stream. After it was checked that the rate of polymerization (the rate is defined as the value obtained by dividing the weight of the polymer, from which volatile components have been removed by heating, by the weight of the polymer liquid itself before the volatile components are removed) reached 80% by weight or more, 1 part by weight of 4-hydroxybutyl acrylate was added to the product, and the mixture was further heated at 100° C. for 12 hours. As a result, a butyl acrylate polymer having hydroxyl groups at both ends was obtained. The resulting polymer was diluted to about 20% with ethyl acetate, and the dilution was centrifuged at a centrifugal force of 2,000 g for 1 hour, so that a polymer solution (transparent and green) was obtained as a supernatant. Subsequently, 23 parts by weight of a sulfonic acid-type cation-exchange resin was added to 1,000 parts by weight of the solution. After the mixture was stirred at room temperature (23° C.) for 2 hours, the ion-exchange resin was removed, and a transparent colorless solution was obtained. The solvent was removed from the solution by heating and drying under reduced pressure, so that a polymer having hydroxyl groups at molecular ends and other sites was obtained.

<Synthesis of Polymer Having Reactive Silicon Groups at Molecular Ends and so on>

To 100 parts by weight of the polymer was added 1.2 parts by weight of 3-isocyanatopropyltrimethoxysilane, which has trimethoxysilane and isocyanate groups. The hydroxyl groups of the polymer were allowed to react with the isocyanate group of the silane by heating at 80° C. for 5 hours, so that a polymer (42,000 in weight average molecular weight) having reactive silicon groups at molecular ends and other sites was obtained. To 100 parts by weight of the resulting polymer were added 1 part by weight of aluminum trisacetylacetate as a curing catalyst, 1 part by weight of a trimethylolpropane adduct of tolylene diisocyanate (CORONATE L, manufactured by Nippon Polyurethane Industry Co., Ltd.) as a crosslinking agent, and the materials were uniformly mixed and degassed to give a pressure-sensitive adhesive composition.

(Preparation of Pressure-Sensitive Adhesive Layer)

The pressure-sensitive adhesive composition was applied to a 38 μm-thick, silicone-release-treated, polyethylene terephthalate (PET) film so that a pressure-sensitive adhesive layer with a dry thickness of 25 μm could be formed, and subjected to a crosslinking treatment at 150° C. for 3 minutes, so that a pressure-sensitive adhesive layer with a gel fraction of 62% by weight was obtained. The pressure-sensitive adhesive layer was transferred onto a polarizing film (a product obtained by a process including impregnating a polyvinyl alcohol film with iodine, stretching the film, and then bonding triacetylcellulose films to both sides thereof with an adhesive interposed therebetween) to form an adhesive optical member according to the invention.

### Example 2

### Preparation of Pressure-Sensitive Adhesive Composition

<Synthesis of Polymer Having Hydroxyl Groups at Molecular Ends and so on>

To a four-necked flask, equipped with a mechanical stirrer, a nitrogen-introducing inlet, a condenser tube, and a rubber septum, were added 250 parts by weight of butyl acrylate and 1.0 part by weight of 2,2′-bipyridine, and the air in the system was replaced by nitrogen. Under a nitrogen stream, 0.3 parts by weight of copper bromide was added to the mixture. Subsequently, the reaction system was heated at 100° C., and 1.2 parts by weight of 2-hydroxyethyl 2-bromo-2-methylpropionate as an initiator was added to initiate polymerization. Without addition of any solvent, the mixture was subjected to polymerization at 100° C. for 12 hours under a nitrogen stream. After it was checked that the rate of polymerization (the rate is defined as the value obtained by dividing the weight of the polymer, from which volatile components have been removed by heating, by the weight of the polymer liquid itself before the volatile components are removed) reached 80% by weight or more, 50 parts by weight of methyl methacrylate was added through the rubber septum, and the mixture was further heated at 100° C. for 5 hours. After it was checked that the rate of polymerization was 80% by weight or more, 1.7 parts by weight of 4-hydroxybutyl acrylate was added to the polymerization system, and the mixture was further heated at 100° C. for 12 hours. As a result, a butyl acrylate-methyl methacrylate diblock polymer having hydroxyl groups at both ends was obtained. The resulting diblock polymer was diluted to about 20% with ethyl acetate, and the dilution was centrifuged at a centrifugal force of 2,000 g for 1 hour, so that a diblock polymer solution (transparent and green) was obtained as a supernatant. Subsequently, 23 parts by weight of a sulfonic acid-type cation-exchange resin was added to 1,000 parts by weight of the solution. After the mixture was stirred at room temperature (23° C.) for 2 hours, the ion-exchange resin was removed, and a transparent colorless solution was obtained. The solvent was removed from the solution by heating and drying under reduced pressure, so that a polymer having hydroxyl groups at molecular ends was obtained.

<Synthesis of Polymer Having Reactive Silicon Groups at Molecular Ends and so on>

To 100 parts by weight of the polymer was added 4 parts by weight of dicyclohexylmethane-4,4′-diisocyanate, and the mixture was heated at 80° C. for 5 hours so that isocyanate groups were introduced to hydroxyl groups of the polymer through a urethane bond. Subsequently, 1.3 parts by weight of 3-aminopropyltrimethoxysilane was added, and the amino group of the silane was allowed to react with the isocyanate groups to form urea bonds, so that a polymer having reactive silicon groups at molecular ends (28,000 in weight average molecular weight) was obtained. To 100 parts by weight of the resulting polymer were added 2 parts by weight of aluminum trisacetylacetate as a curing catalyst, 2 parts by weight of a trimethylolpropane adduct of tolylene diisocyanate (CORONATE L, manufactured by Nippon Polyurethane Industry Co., Ltd.) as a crosslinking agent, and 0.3 parts by weight of 3-glycidoxypropyltrimethoxysilane as a silane coupling agent, and the materials were uniformly mixed and degassed to give a pressure-sensitive adhesive composition.

(Preparation of Adhesive Optical Member)

The pressure-sensitive adhesive composition was applied to a 38 μm-thick, silicone-release-treated, polyethylene terephthalate (PET) film so that a pressure-sensitive adhesive layer with a dry thickness of 25 μm could be formed, and subjected to a crosslinking treatment at 150° C. for 3 minutes, so that a pressure-sensitive adhesive layer with a gel fraction of 66% by weight was obtained. The pressure-sensitive adhesive layer was transferred onto a polarizing film (a product obtained by a process including impregnating a polyvinyl alcohol film with iodine, stretching the film, and then bonding triacetylcellulose films to both sides thereof with an adhesive interposed therebetween) to form an adhesive optical member according to the invention.

### Example 3

### Preparation of Adhesive Optical Member

To 100 parts by weight of a polyoxypropylene polymer having a methyldimethoxysilyl group at a molecular end (Kaneka Silyl SAX243 manufactured by Kaneka Corporation, 21,000 in weight average molecular weight) were added 2 parts by weight of aluminum trisacetylacetate as a curing catalyst and 2 parts by weight of a trimethylolpropane adduct of tolylene diisocyanate (CORONATE L, manufactured by Nippon Polyurethane Industry Co., Ltd.) as an isocyanate compound. After the materials were uniformly mixed and degassed, the mixture was applied to a 38 μm-thick, silicone-release-treated, PET film so that a pressure-sensitive adhesive coating with a dry thickness of 25 μm could be formed. The resulting coating was subjected to a crosslinking treatment at 150° C. for 3 minutes, and then transferred onto a polarizing film (a product obtained by a process including impregnating a polyvinyl alcohol film with iodine, stretching the film, and then bonding triacetylcellulose films to both sides thereof with an adhesive interposed therebetween) to form an adhesive optical member according to the invention. The resulting pressure-sensitive adhesive layer had a gel fraction of 60% by weight. The adhesive optical film was installed in a practical liquid crystal panel. After the panel was stored at 60° C. for 300 hours, it was observed whether color irregularities or white spots occurred after the display. As a result, none of them were observed. It can be concluded that the pressure-sensitive adhesive (based on the polyoxypropylene polymer) has a positive birefringence effect to cancel the negative birefringence of triacetylcellulose.

### Example 4

### Preparation of Adhesive Optical Member

To 100 parts by weight of the polyoxypropylene polymer of Example 3 having a methyldimethoxysilyl group at a molecular end were added 1.5 parts by weight of bisacetylacetodiisopropoxytitanium as a curing catalyst, 2 parts by weight of a trimethylolpropane adduct of tolylene diisocyanate (CORONATE L, manufactured by Nippon Polyurethane Industry Co., Ltd.) as an isocyanate compound, and 0.3 parts by weight of 3-glycidoxypropyltrimethoxysilane as a silane coupling agent, and the materials were uniformly mixed and degassed. The mixture was then applied to a 38 μm-thick, silicone-release-treated, PET film so that a pressure-sensitive adhesive coating with a dry thickness of 25 μm could be formed, and subjected to a crosslinking treatment at 150° C. for 3 minutes. The resulting coating was transferred onto a polarizing film (a product obtained by a process including impregnating a polyvinyl alcohol film with iodine, stretching the film, and then bonding triacetylcellulose films to both sides thereof with an adhesive interposed therebetween) to form an adhesive optical member according to the invention. The resulting pressure-sensitive adhesive layer had a gel fraction of 71% by weight.

### Comparative Example 1

An adhesive optical member was prepared using the same process as in Example 1, except that the isocyanate compound was not added. The resulting pressure-sensitive adhesive layer had a gel fraction of 60% by weight.

### Comparative Example 2

An adhesive optical member was prepared using the same process as in Example 3, except that the isocyanate compound was not added. The resulting pressure-sensitive adhesive layer had a gel fraction of 58% by weight.

The resulting adhesive optical members were subjected to the evaluation tests described below. Table 1 shows the evaluation results.

(Adhering Strength)

The adhesive optical member (25 mm in width) was press-bonded to a non-alkali glass plate (#1737 manufactured by Corning Incorporated) by using a 2 kg roller reciprocating once on the optical member. The resulting laminate was autoclaved at 50° C. and 0.5 MPa for 30 minutes and then allowed to stand for 3 hours under the conditions of 23° C. and 50% RH. Subsequently, under the same conditions, the peel adhering strength (N/25 mm) was measured at a peeling angle of 90° and a peeling rate of 300 mm/minute. For example, this adhering strength (at initial stage) is preferably from 3 to 10 N/25 mm, more preferably from 5 to 9 N/25 mm, for sufficient adhesion (pressure-sensitive adhesion) of the optical member.

(Adhering Strength after Heating)

Alternatively, after the autoclaving, the laminate was stored at 70° C. for 6 hours and allowed to stand for 3 hours under the conditions of 23° C. and 50% RH. Under the same conditions, the peel adhering strength (N/25 mm) was measured as the adhering strength after heating at a peeling angle of 90° and a peeling rate of 300 mm/minute. For easy removal of the optical member, this adhering strength (after heating) is preferably prevented from being higher than the initial adhering strength. For example, therefore, this adhering strength (after heating) is preferably from 5 to 14 N/25 mm, more preferably from 6 to 13 N/25 mm.

(Durability)

The adhesive optical member (12 inches in width size) obtained in each of the examples and the comparative examples was bonded to a 0.5 mm-thick, non-alkali glass plate (#1737 manufactured by Corning Incorporated). The resulting laminate was autoclaved at 50° C. and 0.5 MPa for 30 minutes and further stored in an atmosphere at 60° C. and 90% RH for 500 hours, and then the state of the optical member was evaluated. The state with no peeling or lifting was expressed by the symbol “◯,” and the state with any peeling or lifting was expressed by the symbol “X.”

TABLE 1

| | | Adhering | |
|---|---|---|---|
| | Adhering | strength after | Durability |
| | strength | heating | (at 60° C. and 90% |
| | (N/25 mm) | (N/25 mm) | for 500 hr) |
| Example 1 | 8.2 | 9.8 | ◯ |
| Example 2 | 6.5 | 10.4 | ◯ |
| Example 3 | 7.5 | 12.7 | ◯ |
| Example 4 | 6.5 | 9.3 | ◯ |
| Comparative | 8.0 | 9.1 | X |
| Example 1 | | | |
| Comparative | 7.1 | 11.6 | X |
| Example 2 | | | |

The results in Table 1 show that all the examples exhibited satisfactory levels of initial adhering strength and post-heating adhering strength and also good durability. In the comparative examples where no isocyanate compound (crosslinking agent) was added, however, a failure such as lifting or peeling occurred, and the results were worse than those in the examples, although the pressure-sensitive adhesive layer had a satisfactory level of gel fraction.

1.-8. (canceled)

9. An adhesive optical member, comprising a pressure-sensitive adhesive layer obtained by a pressure-sensitive adhesive composition for an optical member provided on one or both sides of the optical member, the composition comprising: 100 parts by weight of a polymer having a reactive silicon group at a molecular end or in the vicinity of the end and having a weight average molecular weight of 2,000 to 50,000; 0.02 to 5 parts by weight of a curing catalyst; and 0.2 to 5 parts by weight of an isocyanate compound.

10. The adhesive optical member according to claim 9, wherein the polymer having a reactive silicon group at a molecular end or in the vicinity of the end is a product synthesized by introducing a reactive silicon group to a hydroxyl group of a polymer that has the hydroxyl group at a molecular end or in the vicinity of the end and has a weight average molecular weight of 2,000 to 50,000.

11. The adhesive optical member according to claim 10, wherein the polymer having a hydroxyl group at a molecular end or in the vicinity of the end is a polyacrylic ester-based polymer or a polyoxyalkylene-based polymer.

12. The adhesive optical member according to claim 9, wherein the pressure-sensitive adhesive composition for an optical member further comprises 0.02 to 2 parts by weight of a silane coupling agent.

13. The adhesive optical member according to claim 9, wherein the pressure-sensitive adhesive layer has a gel fraction of 40 to 85% by weight.

14. The adhesive optical member according to claim 9, wherein the adhering strength at initial stage of the pressure-sensitive adhesive layer to a non-alkali glass is from 3 to 10 N/25 mm under conditions of a peeling angle of 90° and a peeling rate of 300 mm/minute.

15. The adhesive optical member according to claim 9, wherein the adhering strength after heating at 70° C. for 6 hours of the pressure-sensitive adhesive layer to a non-alkali glass is from 5 to 14 N/25 mm under conditions of a peeling angle of 90° and a peeling rate of 300 mm/minute.

16. The adhesive optical member according to claim 9, wherein the optical member is at least one selected from a polarizing plate, a retardation plate, and an elliptically polarizing plate.
